(19) United States
(12) Patent Application Publication
(10) Pub. No.: US 2008/0075129 A1
(43) Pub. Date: Mar. 27, 2008

(54) T-CARRIER MULTIPLEXER AND DEMULTIPLEXER WITH ADD/DROP CAPABILITY

(75) Inventors: Eugene K. Norgard, San Ramon, CA (US); Gerard J. Miille, Pleasanton, CA (US); Edwin W. Len, San Ramon, CA (US); Sammy P. Wong, Union City, CA (US); Drew M. Gordon, San Carlos, CA (US); Raymond W. Dolejs, Palatine, IL (US); Laurie A. Miille, Pleasanton, CA (US); Bruce A. Harrison, Lisle, IL (US); Jeff Plesniak, Plainfield, IL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: CHARLES INDUSTRIES, LTD., Rolling Meadows, IL (US)

(21) Appl. No.: 11/534,549

(22) Filed: Sep. 22, 2006

(51) Int. Cl. H04J 3/04

(52) U.S. Cl. 370/535

(57) ABSTRACT

Embodiments of the invention provide a system for supporting numerous multiplexed and demultiplexed T1 signals and additional Ethernet signals between two DS-3 signals. In an embodiment, the multiplexer device is housed within a single rack unit on a standard 19″ or 23″ rack. In a further embodiment, all T1, Ethernet, alarm driver, and power connections are made from the front of the multiplexer unit, allowing easier access to the device connections restricted spaces. In a further embodiment, the system provides redundancy for the T3, T1, and Ethernet circuits, allowing error remediation. The system may also allow error detection for the associated telecommunications network.

### RELATED APPLICATIONS

This application is related to copending U.S. application Ser. No. 11/388,702, filed Mar. 24, 2006, entitled “Space Saving Rack Mountable Electronic Component Housing,” which claims priority to like-titled provisional application Ser. No. 60/664,915, filed Mar. 24, 2005, both of which applications are herein incorporated by reference for all that they teach and disclose without exclusion of any part thereof.

### BACKGROUND

Carrier multiplexers are used in the telecommunications and other industries to allow the combination of various signals onto a fewer number of carriers and to extract multiple signals from a carrier signal. A T3 carrier carries 672 64 kbps channels, while a T1 carrier carries 24 64 kbps channels. Thus, the T3 carrier can support up to 28 T1 signals, and multiple T1 signals can be multiplexed onto a T3 carrier for transmission and may be demultiplexed from the combined T3 signal at another location.

T1 usage to carry both voice and data circuits is increasingly popular within the telecommunications industry as the need for higher speed connections grow, driven by customer demand for faster internet access, sending of pictures and graphics via cell phones, and the increase demand for cell phone service. The need to provide T1 service for both voice and data is becoming necessary. Existing T3 multiplexers are not designed to support data (via Ethernet) services. In particular, although some of these devices may have been controllable via Ethernet, they did not support Ethernet services for data passing through the device.

T1/T3 multiplexer devices have traditionally been designed to provide a high-speed T3 port which 28 DSX-1 (T1) signals could be multiplexed to and demultiplexed from. Some T3 multiplexer devices provide two T3 ports and are referred to as T3 add/drop multiplexers. The additional T3 port allows the multiplexer to be deployed in a ring configuration that provides circuit protection when faults occur on a T3 span. However, these add/drop multiplexers are not able to provide 28 DSX-1 signals. In addition, they do not provide the ability to carry 10Base-T or 100Base-T Ethernet circuits on the T1 channels.

DS1 signals are often employed for connecting equipment within a given facility. In this case, DSX-1, a low-level signal, is used. When a DS1 leaves the building, it generally is converted to a T1 signal and is boosted to a higher level and superimposed on a DC voltage, enabling repeaters in the field to be powered from the DC power. Frequent repeaters clean and strengthen the signal. DS3 signals are almost always used within buildings, for interconnections and as an intermediate step before being multiplexed onto a SONET circuit since a T3 signal degenerates after about 900 feet unless repeated. The designations “DSX” refer to different levels of digital service, with DS-1 ordinarily being carried on a T1 line, and DS-3 being carried on a T3 line. T1 links usually consist of a pair of twisted pair lines, whereas T3 links generally consist of a pair of copper coaxial cables.

Multiplexers that multiplex and demultiplex T1 and T3 signals among themselves are often designated as “M13” multiplexers. Such devices must typically be mounted in a rack divided into slots or rack units having a vertical dimension of 1.75 inches. Most M13 multiplexers are such that they require 3 or more slots for mounting. However, this substantial footprint does not allow sufficient room to add new equipment as the complexity of networks increases. Moreover, the limited amount of free space between rack components can negatively impact cooling of the multiplexer and other components.

In addition, the throughput required of modern multiplexers is high, such that equipment failure can impact many different remote communications systems. As such, there is a need for improved testing of the multiplexer and associated links.

### SUMMARY

In overview, embodiments of the invention provide a system for supporting up to 28 multiplexed and demultiplexed T1 signals and up to four 10/100 Base-T Ethernet signals between two DS-3 signals. In an embodiment of the invention, the multiplexer device is housed within a single rack unit on a standard 19″ or 23″ rack used for telecommunications equipment. In a further embodiment of the invention, all T1 connections, Ethernet connections, alarm driver connections, and power connections are made from the front of the multiplexer unit. The features of this embodiment of the invention allow easier access when the device is installed in cramped or restricted areas. For example, the front access feature allows the T3 add/drop multiplexer to be installed against a wall, where ready access to the rear of a standard unit may be difficult or impossible.

In a further embodiment of the invention, the system provides redundancy for the T3, T1, and Ethernet circuits. This is useful in avoiding excess service delays due to nonfunctioning components. In an embodiment of the invention, the system provides additional functionality for trouble-shooting problems in the telecommunications network. This additional functionality includes generating and receiving T1 test signals and providing a mechanism to loop the T1 or T3 signals back to the originating source.

Other objects and advantages of the invention will become apparent upon reading the following detailed description and upon reference to the drawings.

### BRIEF DESCRIPTION OF THE FIGURES

FIG. 1 is a perspective view of an assembled chassis according to an embodiment of the invention;

FIG. 2 is a perspective view of an assembled multiplexer according to an embodiment of the invention;

FIG. 3 is a schematic view of a multiplexer assembly according to an embodiment of the invention;

FIG. 4 is a general schematic view showing the function and connectivity of T1/T3 portions of an add/drop multiplexer module according to an embodiment of the invention;

FIG. 5 is a more detailed schematic illustration of an add/drop multiplexer module according to an embodiment of the invention;

FIG. 6 is a schematic illustration of a network having a ring topology supporting T3 transmissions and the pass-through of T1 signals according to an embodiment of the invention;

FIG. 7 is a flow chart showing a process of passing a T1 signal across a ring network according to an embodiment of the invention; and

FIG. 8 illustrates an add/drop multiplexer module including a failure detection module.

### DETAILED DESCRIPTION

As discussed above, embodiments of the invention provide a system for supporting a large number, e.g., 28, multiplexed and demultiplexed T1 signals as well as a sufficient number, e.g., four, 10/100 Base-T Ethernet signals between two DS-3 signals. The multiplexer device may be housed within a single rack unit on a standard rack used for telecommunications equipment, and in a further embodiment may have all connections, e.g., T1 connections, Ethernet connections, alarm driver connections, and power connections, located at the front of the unit to allow easier access in cramped or restricted areas. Also as discussed in overview, certain embodiments of the invention provide redundancy for the T3, T1, and data circuits. Finally, embodiments of the invention provide trouble-shooting functionality to generate and receive T1 test signals and to loop the T1 or T3 signals back to the originating source.

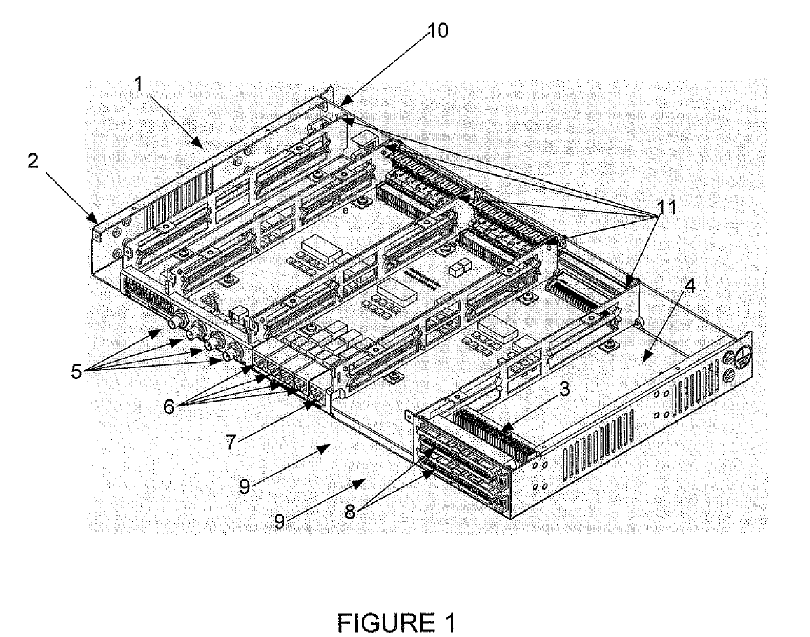

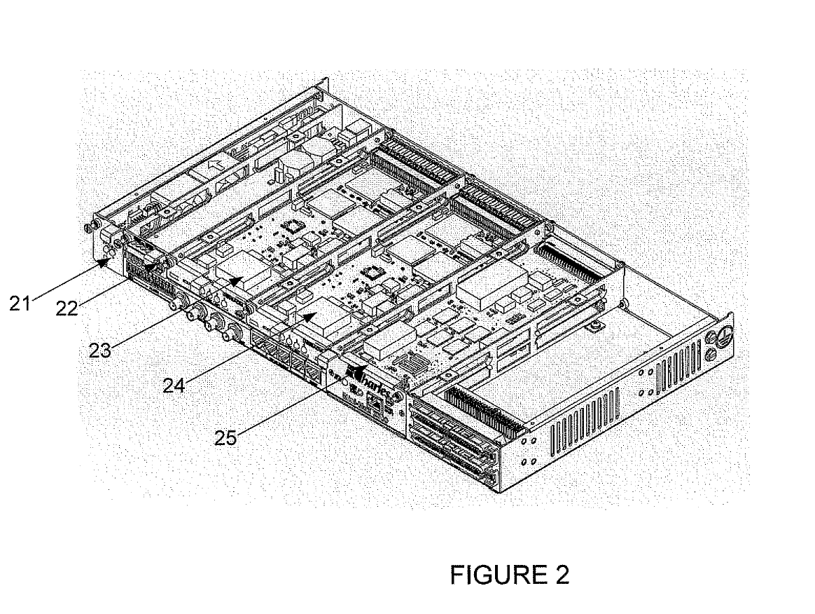

FIG. 1 shows a perspective view of an assembled chassis, with the top cover removed, according to an embodiment of the invention. FIGS. 1 and 2 illustrate the physical layout of the multiplexer 1 according to an embodiment of the invention. FIG. 1 in particular is a diagram, omitting most boards for clarity, showing a multiplexer chassis 2 adapted to support a number of components and assemblies as discussed hereinafter.

The multiplexer 1 comprises a T1 Input connector board 3 attached to the main connector board 4 via, for example, a 112-pin connector. These two pieces 3, 4 form a main connector board assembly. The main connector board assembly may be assembled prior to insertion in to the chassis 2. In an embodiment of the invention, the main connector board assembly exposes on the front side 9 of the chassis 2 a number of connectors including mini-bnc connectors 5, ethernet connectors 6, a management port 7, and t1 connectors 8 associated with the t1 input connector board 3. A backplane 10 is then connected to the main connector board assembly, such as via two 180-pin connectors and one 100-pin connector. The backplane 10 exposes connectors to receive circuit boards.

An appropriate number of card guide brackets 11 are mounted to the chassis 2, such as by screws passing through the main connector assembly and into mounting studs (not shown) attached to the chassis 2. This secures the card guide brackets and main connector assembly to the chassis 2. The backplane 10 is then secured, for example, by attaching it to the chassis 2 at the four corners of the circuit board 4 and may also be attached to one or more of the card guide brackets 11. A top cover (not shown), such as one that bends around the rear of the backplane 10, may be used to enclose the shelf. The top cover preferably is attached to the chassis 2 and card guide brackets 11.

FIG. 2 shows a perspective view of an assembled multiplexer 20 according to an embodiment of the invention (again omitting the top cover) based on the assembly 1 of FIG. 1, with the appropriate circuit boards and modules inserted. A fan module 21 may be used to provide airflow to control the operating temperature inside the system. A power module 22 is used to deliver two external 48 VDC power sources to the Fan Module 21, as well as an add/drop multiplexer module 23, a redundant add/drop multiplexer module 24, and a system control module 25. The add/drop multiplexer modules 24, 25 provide the circuit paths for the t1, t3, and Ethernet circuits. In an embodiment of the invention, the system control module 25 houses the microprocessor and software to manage and run the multiplexer system 20.

The configuration and enclosure of the multiplexer as shown in FIG. 2 may be as shown in copending U.S. application Ser. No. 11/388,702, filed Mar. 24, 2006, entitled “Space Saving Rack Mountable Electronic Component Housing,” which is herein incorporated by reference in its entirety.

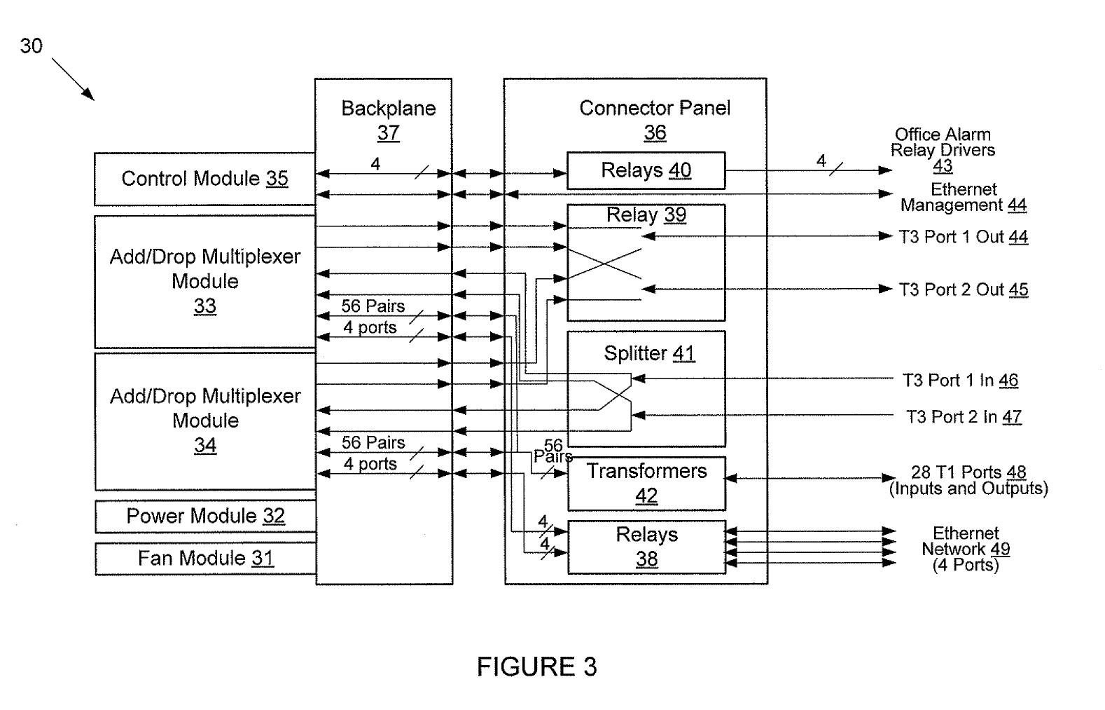

FIG. 3 shows a schematic view of a multiplexer assembly 30 in keeping with the multiplexer assembly 2 according to an embodiment of the invention. In particular, the multiplexer assembly 30 comprises a fan module 31 to provide airflow to control the operating temperature inside the system as discussed above. The multiplexer assembly 2 also comprises a power module 32, an add/drop multiplexer module 33, a redundant add/drop multiplexer module 34, and a system control module 35, all as discussed above. These components are interfaced to the frontal connector panel 36 via the backplane 36 and the internal connections that it exposes to the relevant cards. The connector panel 36 comprises a number of active components including relays 38, 39, 40, a splitter 41, and a set of transformers 42.

As can be seen, the control module 35 connects through the backplane 37 and the connector panel 36 to send and receive Ethernet management communications 44. The control module 35 also connects through the backplane 37 to relays 40 on the connector panel 36, which are controlled by the control module 35 to output signals 43 associated with office alarms or other management functionality. In the illustrated example, there are 4 outputs from the relays 40, but a smaller or larger number of relays and outputs may be used as desired.

The redundant add/drop multiplexer modules 33, 34 each provide two T3 outputs and inputs, 28 T1 inputs and outputs (56 pairs), and four Ethernet ports. These signals are supplied via the backplane 37 to appropriate components and/or outputs of the connector panel 36. The relay unit 39 comprises two relays for selecting either the T3 outputs of the primary add/drop multiplexer module 33 or those of the backup add/drop multiplexer module 34 to output at T3 outputs 44, 45. Although the connection is not explicitly disclosed to avoid obscuring the components in the figure, the relays of component 39 may be controlled by the control module 35, as is true for the other elements shown in FIG. 3.

The splitter module 41 is configured, as shown, to receive two T3 input signals 46, 47 and to provide these signals through the backplane 37 to the T3 inputs of both add/drop multiplexer modules 33, 34. The 28 T1 inputs and outputs (56 pairs) of the add/drop multiplexer modules 33, 34 are connected through the backplane 37 to the transformers 42 of the connector panel 36. The transformers 42 serve to transform the incoming T1 signals (incoming portion of signals 48) for use by the add/drop multiplexer modules 33, 34. The transformers 42 also serve to transform the outgoing T1 signals from the add/drop multiplexer modules 33, 34 into appropriate form for transmission (outgoing portion of signals 48).

Finally, relays 38, in communication with the add/drop multiplexer modules 33, 34 via the backplane 37, provide Ethernet signals from the add/drop multiplexer modules 33, 34 to output signal 49. In addition, they provide the input portion of output signal 49 to the add/drop multiplexer modules 33, 34.

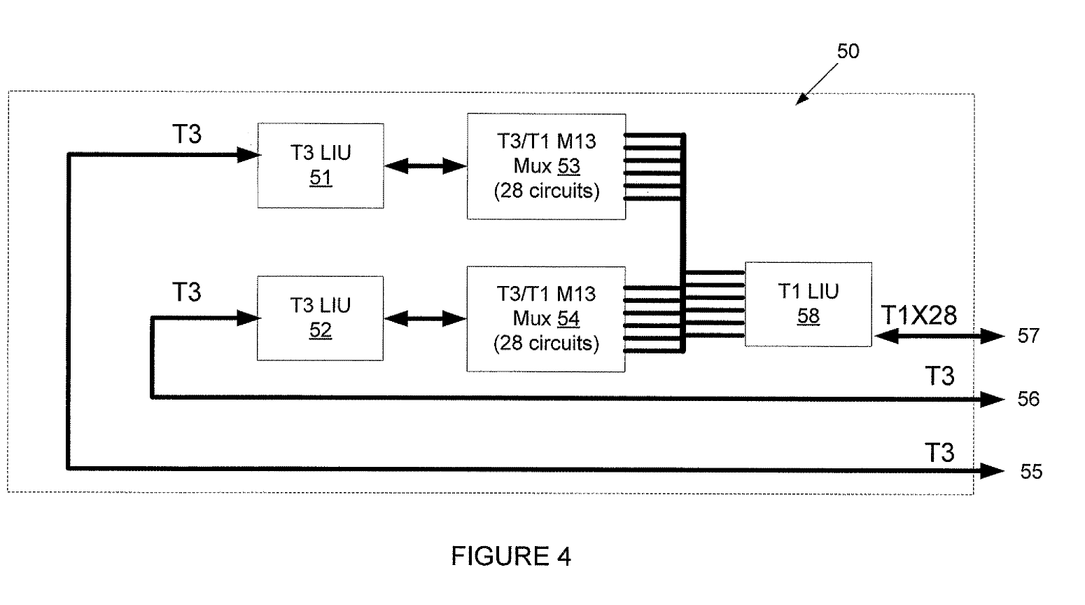

FIG. 4 is a general schematic view showing the function and connectivity of the T1/T3 portions of the add/drop multiplexer modules 33, 34. It will be appreciated that the illustrated novel system adds Ethernet functionality such that the Ethernet circuits are multiplexed into one or several T1 signals and combined with other T1 signals to be multiplexed into a T3 signal.

As shown in FIG. 4, the add/drop multiplexer module 50 comprises two line input units (LIU's) 51, 52 connecting two respective T3 signals 55, 56 to two respective T3 multiplexers 53, 54. Twenty-eight T1 signals 57 are connected to the T3 multiplexers 53, 54 via a T1 line input unit 58.

In an embodiment of the invention, the system combines the T1, T3, and Ethernet control circuitry (i.e., modules 33 and 34) on a single printed circuit board. This allows the same printed circuit board to be installed in an adjacent slot so that 1 for 1 redundancy for the T1, T3, and Ethernet circuits can be provided.

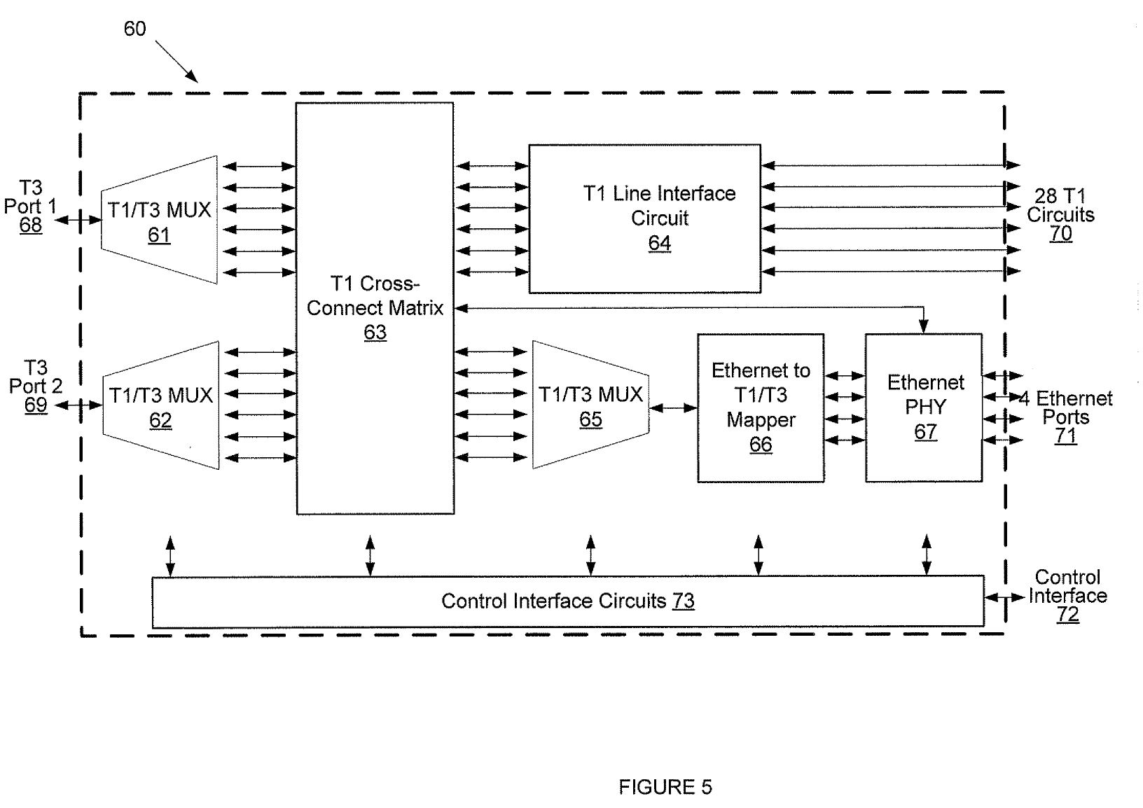

FIG. 5 is a schematic illustration of an add/drop multiplexer module such as add/drop multiplexer modules 33, 34 in greater detail. The add/drop multiplexer module 60 comprises two T1/T3 multiplexers 61, 62 connected to two respective T3 ports, Port 1 (68) and Port 2 (69). The multiplexers are also each connected via 28 T1 circuits to a T1 cross-connect matrix 63. A T1 line interface circuit 64 is also connected to the T1 cross-connect matrix 63 via 28 T1 circuits, as is a third T1/T3 multiplexer 65.

The T1 line interface circuit 64 is also connected to 28 T1 circuits outside the device 60. An Ethernet T1/T3 mapper 66 is also connected to the third T1/T3 multiplexer 65 and exposes four Ethernet signals to Ethernet physical layer device (PHY) 67. Those of skill in the art will appreciate that many types and configurations of mapper may be used for the Ethernet T1/T3 mapper 66. However, in an embodiment of the invention, the mapper 66 is an ETHERMAP PDH Device (Ethernet Over PDH Mapper) manufactured by TRANSWITCH and sold as model no. TXC-07861. The ETHERMAP PDH device maps Ethernet frames into Plesiochronous Digital Hierarchy (PDH) signals (T1 and DS3), optimized for the access network using GFP-F/HDLC, PDH VCAT and LCAS. T1 signals can be bonded together to form a Virtual Container Group (VCG) to provide a bandwidth pipe connecting Ethernet ports across a standard telecom network.

The Ethernet PHY 67 exposes four Ethernet ports outside of the device 60. The operation of the components 61-67 of the module 60 is controlled by the control module 35 in an embodiment of the invention. The control is via control interface circuits 73 illustrated schematically in FIG. 5. A control interface input 72 provides connectivity to the control module 35 via the backplane 37.

In operation, the add/drop multiplexer module 60 generally serves to multiplex T1 and Ethernet signals into T3 signals and to demultiplex T1 signals from T3 signals. The demultiplexed T1 signals may comprise Ethernet signals. Thus, the multiplexing of Ethernet signals into one or more T3 signals is preceded by a conversion of the Ethernet signals into T1 signals which are input to the T1 cross-connect matrix 63. The demultiplexing of Ethernet signals from one or more T3 signals proceeds first via the demultiplexing of T1 signals from the T3 signals, after which any Ethernet signals in the T1 signals are extracted.

As noted above, the T1 cross-connect matrix 63 is a matrix that can connect any T1 signal with any other T1 signal. As such, the add/drop multiplexer module 60 can add/drop T1 signals (and Ethernet signals as well) into/out of the T3 stream selectively. This allows effective implementation of ring structures and ring pass through architectures as will be discussed below. In addition, the ability to connect any two T1 lines allows the system to create loops, which can be used for system diagnostic purposes. As shown, in a further embodiment of the invention, the Ethernet PHY 67 is directly linked to the T1 cross-connect matrix 63, preferably in addition to, but potentially as an alternative to, being linked through the mapper 63 and the T1/T3 multiplexer 65.

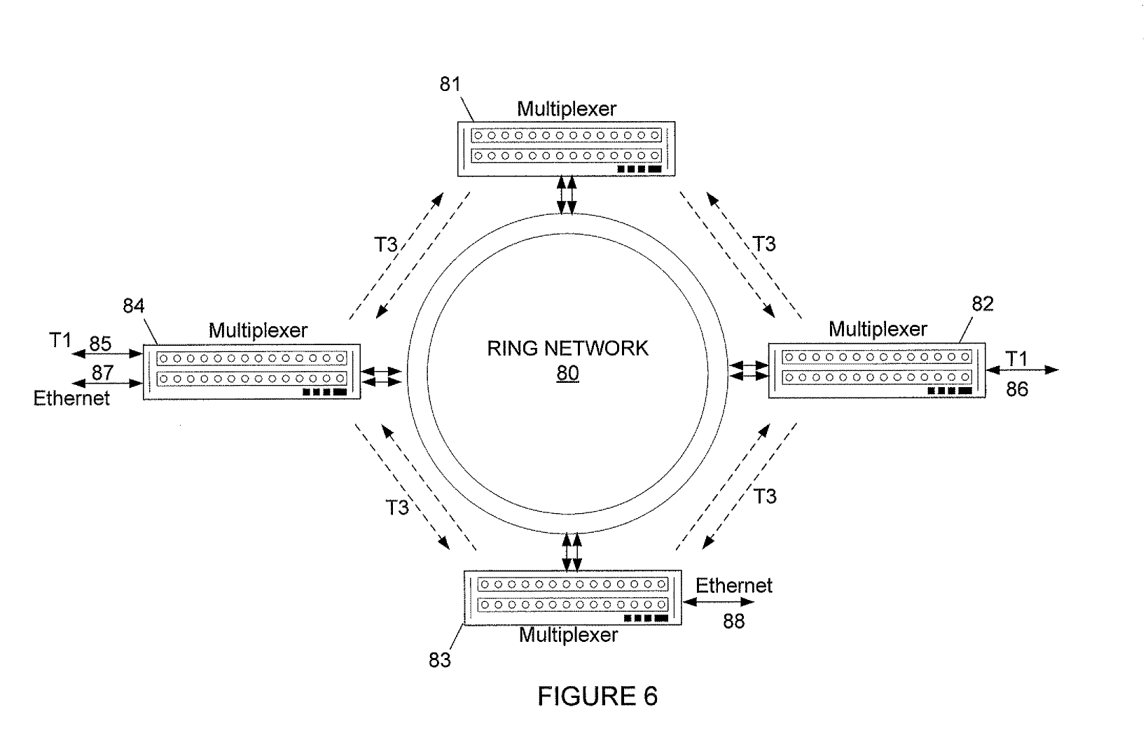

FIG. 6 is a schematic illustration of a network having a ring topology supporting T3 transmissions and the pass-through of T1 signals. The ring network example 80 comprises four multiplexer assemblies 81, 82, 83, 84 such as multiplexer assembly 30 illustrated above (also shown in FIG. 2 with cover omitted). The multiplexers 81, 82, 83, 84 are connected in a ring configuration. Each multiplexer 81, 82, 83, 84 has one of its T3 ports connected to one other multiplexer and its other T3 port connected to a second other multiplexer.

Thus, as shown multiplexer 81 is connected by one T3 port to multiplexer 82 and by another T3 port to multiplexer 84. Similarly, multiplexer 82 is connected by one T3 port to multiplexer 81 and by another T3 port to multiplexer 83. Multiplexer 83 is connected by one T3 port to multiplexer 82 and by another T3 port to multiplexer 84. Finally, multiplexer 84 is connected by one T3 port to multiplexer 81 and by another T3 port to multiplexer 83.

In addition, in the illustrated example, a first T1 signal is connected to multiplexer 84 via port 85 and a second T1 signal is connected to multiplexer 82 via port 86. The ring topology combined with the add/drop functions of the multiplexers, in particular multiplexers 84 and 82, allow redundant passage of the T1 signals across the ring 80. Although the illustrated example shows the traversal of the ring 80 by T1 signals, the illustrated embodiment of the invention also allows the traversal of the ring 80 by an Ethernet signal or a combination of Ethernet and T1 signals.

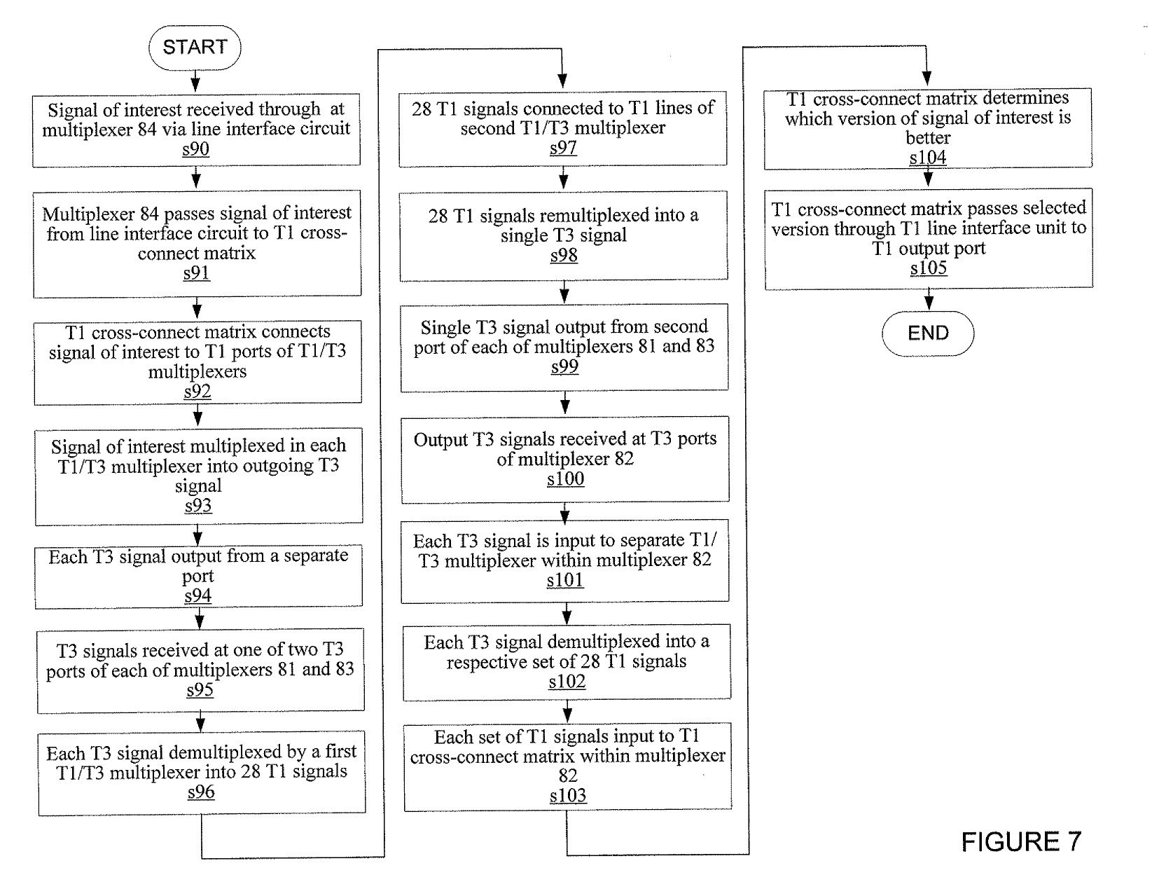

Referring to the embodiment of the invention shown in FIG. 6, the passage of a T1 signal of interest received at port 85 across the ring 80 to exit at port 86 is illustrated in greater detail in FIG. 7. At stage s90, the T1 signal of interest is received through port 85 at multiplexer 84 via a line interface circuit. At stage s91, the multiplexer 84 passes the signal of interest from the line interface circuit to the T1 cross-connect matrix. From the T1 cross-connect matrix, the received T1 signal of interest is connected to the T1 ports of two T1/T3 multiplexers at stage s92. At stage s93, the T1 signal of interest is multiplexed in each T1/T3 multiplexer into an outgoing T3 signal. At stage s94, each such T3 signal is output from a separate port of the device.

Using the illustrative connections illustrated in FIG. 6, the output T3 signals are received at one of two T3 ports of each of multiplexers 81 and 83 in stage s95. Upon such receipt, the T3 signal is demultiplexed by a first T1/T3 multiplexer into 28 T1 signals at stage s96, including the T1 signal of interest, and these signals are connected to the T1 lines of a second T1/T3 multiplexer within the device at stage s97. At stage s98, the signals so received are remultiplexed into a single T3 signal, which is output at stage s99 from the second port of each of multiplexers 81 and 83.

Using the illustrative connections illustrated in FIG. 6, these output T3 signals from multiplexers 81 and 83 are received at respective ones of two T3 ports of multiplexer 82 at stage s100. Each such T3 signal is input to a separate T1/T3 multiplexer within multiplexer 82 at stage s101 and is demultiplexed into a respective set of 28 T1 signals including the T1 signal of interest at stage s102. Each of these two sets of T1 signals is input to a T1 cross-connect matrix within multiplexer 82 at stage s103. At stage s 104, in an embodiment of the invention, the T1 cross-connect matrix determines which version of the T1 signal of interest is better in terms of one or more predetermined criteria such as signal quality, timing, etc. In stage s105, the T1 cross-connect matrix passes the selected version through a T1 line interface unit to a T1 output port, i.e., port 86. In an embodiment of the invention, the T1 cross-connect matrix 63 executes the signal determination under control of a control module as discussed above.

As shown in FIG. 6, the illustrated example system also allows the passage of Ethernet signals through the example ring 80. In the illustrated example, an Ethernet port 87 at multiplexer 84 is connected via the system to an Ethernet port 88 at multiplexer 83. These signals traverse the ring 80 between nodes 83 and 84 in much the same way as that discussed above for the T1 signals associated with ports 85 and 86. However, instead of being routed around the ring 80 through the T1/T3 multiplexers 61, 62, and being routed into and out of the multiplexer devices via the T1 line interface circuit, the Ethernet signals are routed into and out of the multiplexer devices 83 and 84 via the Ethernet PHY 67. The Ethernet PHY 67 is in communication with the T1 cross-connect matrix 63 either directly or via the Ethernet to T1/T3 mapper 66 and the T1/T3 multiplexer 63.

In the illustrated example, the Ethernet signal enters multiplexer 84 via the Ethernet port, is routed and multiplexed within the device 84 using the mechanisms discussed above, and is connected to the T3 outputs of the device 84 to pass to devices 81 and 83. At device 81, the Ethernet signal is received at one T1/T3 multiplexer 61, extracted and input to the T1 cross-connect matrix 63, output to the other T1/T3 multiplexer 62, and remultiplexed into the outgoing T3 signal. This same process is repeated at device 82 before the signal arrives at destination device 83. At the other T3 Input to device 83, the same signal arrived directly from device 84.

The device 83 selects one or the other signal based on one or more predetermined criteria as discussed above and outputs the selected signal either directly to the Ethernet PHY or first to the T1/T3 multiplexer 65 and then the Ethernet to T1/T3 mapper 66. Once the signal has arrived at the Ethernet PHY 67 of the device 83, it is output at Ethernet port 88 of the device 83.

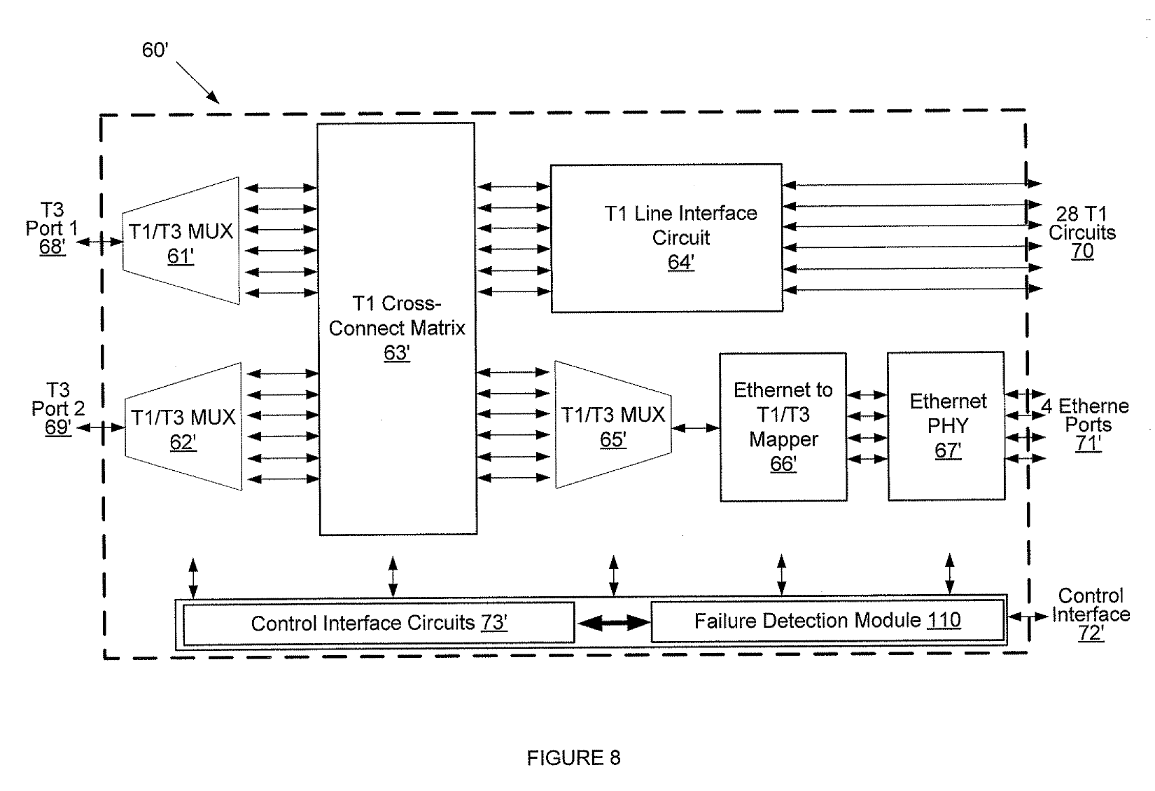

In an embodiment, the invention provides a mechanism to automatically switch out malfunctioning equipment for functional equipment with a minimum of data loss. By providing two add/drop multiplexer modules within the multiplexer unit, one module is able to act as a standby module in the event of a failure. In this embodiment of the invention, failure detection circuits are included in each add/drop multiplexer module and are monitored by the control module. FIG. 8 illustrates an add/drop multiplexer module including a failure detection module 110. The primed reference numbers in FIG. 8 correspond to like unprimed reference numbers in FIG. 5. A failure in any one of the components of the multiplexer unit 60′ may cause the failure detection module 110 to output an error detection signal via control interface 72′. In an alternative embodiment of the invention, certain failures such as a single line failure in the T1 line interface circuit 64′ may be deemed not to be a failure sufficient to cause a switch to the backup add/drop multiplexer module.

In an embodiment of the invention, when one or more failure in the active add/drop multiplexer module, e.g. module 33, is detected, the control module 35 activates relays on the connector panel 36 (e.g., relays 39) to switch the T3 output ports 44, 45 from the active add/drop multiplexer module to the backup add/drop multiplexer module, e.g. module 34, disables circuits on the active add/drop multiplexer module, and activates circuits on the standby add/drop multiplexer module. This process transfers the circuit path from the active add/drop multiplexer module to the backup add/drop multiplexer module. In an embodiment of the invention, the control module also allows the administrator to manually switch between the active and standby add/drop multiplexer modules by software commands via the management port.

In a further embodiment of the invention, the add/drop modules are operable to assist with the troubleshooting of network failures. In one alternative embodiment, the received T3 signal is looped back out of the transmit T3 signal 68, 69 via the T1/T3 Mux 61, 62. In another alternative embodiment, one or more of the T1 circuits contained in the received T 3 signal are looped back out the T1 circuit(s) contained in the transmit T3 signal via the T1 cross-connect matrix 63. In yet another alternative embodiment, one or more of the received T1 signals are looped back out the transmit T1 signal. These loopback functions are contained on each of the add/drop multiplexer modules in an embodiment of the invention and are activated/deactivated through the control module via the management port.

In an alternative embodiment of the invention for assisting with the troubleshooting of network failures, T1 test signals compatible with those provided by standard telecommunications test equipment are inserted into the signal and/or monitored in the signal by the add/drop multiplexer modules. This operation is provided for example by the T1 cross-connect matrix 63, and activates/deactivates a selected test pattern into or from any of the T1 signals or any of the T1circuits within the T3 signal. This test functionality is controlled through the control module 35 via the management port 44.

It will be appreciated that a new and useful system and architecture for T3/T1 multiplexing/demultiplexing have been described herein with respect to several embodiments of the invention, including the best mode known to the inventors for carrying out the invention. Variations of these preferred embodiments will become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention. As noted earlier, all references to “the invention” are intended to reference the particular embodiment(s) of the invention being discussed at that point and are not intended to imply any limitation as to the scope of the invention more generally. All language of distinction and disparagement with respect to certain features is intended to indicate a lack of preference for those features, but not to exclude such from the scope of the invention entirely unless otherwise indicated.

All references, including publications, patent applications, and patents, cited herein are hereby incorporated by reference to the same extent as if each reference were individually and specifically indicated to be incorporated by reference and were set forth in its entirety herein.

I claim:

1. A multiplexer device for processing telecommunications signals, the multiplexer module comprising:
a first add/drop multiplexer module having at least a pair of T3 connections for transferring at least two T3 communications, at least twenty-eight T1 connections for transferring at least twenty-eight T1 communications, and at least one Ethernet connection for transferring at least one Ethernet communication, wherein the add/drop multiplexer module is configured to selectively add at least a selected one of an Ethernet signal from the Ethernet connection and a T1 communication from the T1 connection into one or more of the T3 communications, and to selectively remove at least a selected one of an Ethernet communication and a T1 communication from at least one T3 communication and provide it to at least one of the T1 connections and the Ethernet connections;
a second add/drop multiplexer module having at least a pair of T3 connections for transferring at least two T3 communications, at least twenty-eight T1 connections for transferring at least twenty-eight T1 communications, and at least one Ethernet connection for transferring at least one Ethernet communication, wherein the add/drop multiplexer module is configured to selectively add at least a selected one of an Ethernet signal from the Ethernet connection and a T1 communication from the T1 connection into one or more of the T3 communications, and to selectively remove at least a selected one of an Ethernet communication and a T1 communication from at least one T3 communication and provide it to at least one of the T1 connections and the Ethernet connections;
a T1 port exposed by the multiplexer for passing T1 communications to and from at least one of the first and second add/drop multiplexer modules;
an Ethernet data port exposed by the multiplexer for passing Ethernet communications to and from at least one of the first and second add/drop multiplexer modules;
a selector for selectively connecting a pair of T3 connections to a set of T3 ports exposed by the multiplexer module, wherein the pair of T3 connections is selected from the pair of T3 connections of the first add/drop multiplexer module and the pair of T3 connections of the second add/drop multiplexer module; and
a control module for receiving a control signal and for controlling one or more of the first add/drop multiplexer module, the second add/drop multiplexer module, and the selector.

2. The multiplexer device according to claim 1, further comprising an Ethernet control port exposed by the multiplexer for passing Ethernet control signals to or from the control module.

3. The multiplexer device according to claim 1, further comprising a power module for providing electrical power to at least one of the first add/drop multiplexer module, the second add/drop multiplexer module, the selector, and the control module.

4. The multiplexer device according to claim 1, further comprising a chassis containing the first add/drop multiplexer module, second add/drop multiplexer module, selector, and control module, the chassis being dimensioned, and the contained components being arranged, such that the multiplexer device is mountable within a telecommunications rack mount having a front side and a back side.

5. The multiplexer device according to claim 4, wherein the T1 port, Ethernet data port, and T3 ports are exposed toward from the front side of the rack.

6. The multiplexer device according to claim 2, wherein the T1 port, Ethernet data port, T3 ports, and Ethernet control port are exposed toward from the front side of the rack.

7. The multiplexer device according to claim 4, wherein the device occupies no more than a single rack unit in the telecommunications rack mount.

8. The multiplexer device according to claim 1, wherein each of the first and second add/drop multiplexer modules comprises:
a T1 cross-connect matrix having a plurality of T1 inputs and adapted to selectively connect any one of the plurality of T1 inputs to any other of the plurality of T1 inputs;
a T1/T3 multiplexer in communication with each connection of each pair of T3 connections for translating between the associated T3 communications and a set of demultiplexed T1 signals, wherein the demultiplexed T1 signals are linked to a first one or more of the plurality of T1 inputs of the cross-connect matrix; and
a T1 line interface circuit linking the at least twenty-eight T1 communications associated with the at least twenty-eight T1 connections to a second one or more of the plurality of T1 inputs of the cross-connect matrix.

9. The multiplexer device according to claim 8, wherein each of the first and second add/drop multiplexer modules comprises an Ethernet PHY for linking the Ethernet communications associated with the Ethernet data port to a third one or more of the plurality of T1 inputs of the cross-connect matrix.

10. The multiplexer device according to claim 9, wherein the link between the Ethernet PHY and the cross-connect matrix comprises an Ethernet to T1/T3 mapper and a T1/T3 multiplexer.

11. The multiplexer device according to claim 8, wherein each of the first and second add/drop multiplexer modules comprises control interface circuitry linked to the control module.

12. An add/drop multiplexer module comprising:
a T1 cross-connect matrix having a plurality of T1 inputs and adapted to selectively connect any one of the plurality of T1 inputs to any other of the plurality of T1 inputs;
a T1/T3 multiplexer in communication with each connection of each pair of T3 connections for translating between the associated T3 communications and a set of demultiplexed T1 signals, wherein the demultiplexed T1 signals are linked to a first one or more of the plurality of T1 inputs of the cross-connect matrix; and
a T1 line interface circuit linking the at least twenty-eight T1 communications associated with the at least twenty-eight T1 connections to a second one or more of the plurality of T1 inputs of the cross-connect matrix.

13. The add/drop multiplexer module according to claim 12, further comprising an Ethernet PHY for linking Ethernet communications to the cross-connect matrix.

14. The add/drop multiplexer module according to claim 13, wherein the Ethernet PHY is linked to the cross-connect matrix via an Ethernet to T1/T3 mapper and a secondary T1/T3 multiplexer.

15. The add/drop multiplexer module according to claim 12, further comprising control interface circuitry linked to a control interface of the add/drop multiplexer module for controlling one or more of the T1 cross-connect matrix, the T1/T3 multiplexers, and the secondary T1/T3 multiplexer.

16. A method of using an add/drop module connected to a network to detect a network failure, wherein the add/drop module is configured to selectively create an interconnection between two signals selected from among the group consisting of two T3 signals linked to the network, a T1 signal within one of the two T3 signals, and a T1 signal linked to the network, the method comprising:
receiving a signal from the network over a first connection; and
retransmitting the signal to the network via a second connection.

17. The method according to claim 16, wherein the received and transmitted signals are T3 signals, the method further comprising demultiplexing the received T3 signal into a plurality of component T1 signals and remultiplexing at least one of the plurality of component T1 signals into the transmitted T3 signal.

18. The method according to claim 16, wherein the received and transmitted signals are T1 signals.

19. The method according to claim 16, further comprising inserting a T1 test signal into the received signal to create the transmitted signal.

20. The method according to claim 16, wherein the receive signal comprises a T1 test signal.
